(19) United States
(12) Patent Application Publication
(10) Pub. No.: US 2017/0126623 A1
(43) Pub. Date: May 4, 2017

(54) Protected Subnet Interconnect

(71) Applicant: Ty Lindteigen, Chandler, AZ (US)

(72) Inventor: Ty Lindteigen, Chandler, AZ (US)

(21) Appl. No.: 15/385,843

(22) Filed: Dec. 20, 2016

Related U.S. Application Data
(63) Continuation-in-part of application No. 13/855,713, filed on Apr. 3, 2013.
Application No. 13/855,713 is a continuation-in-part of application No. 14/623,497, filed on Feb. 16, 2015, now abandoned.
Application No. 14/623,497 is a continuation-in-part of application No. 14/799,569, filed on Jul. 14, 2015.
Application No. 14/799,569 is a continuation-in-part of application No. 15/193,026, filed on Jun. 25, 2016.
Application No. 15/193,026 is a continuation-in-part of application No. 14/952,907, filed on Nov. 25, 2015.

(51) Int. Cl. H04L 29/06

(52) U.S. Cl. CPC H04L 63/029; H04L 63/0823; H04L 63/0428

(57) ABSTRACT

The application illustrates methods, apparatuses, and systems for securely transmitting data between a first endpoint device and a second endpoint device comprising the first endpoint device, a first security gateway, a first network infrastructure, a secure network with the secure network enabled to establish a secure communication link directly between the first security gateway and the second security gateway enabling the first endpoint device to transmit data directly to the second endpoint device via the secure communication link.

### CROSS-REFERENCE TO RELATED APPLICATIONS

The present application is a continuation-in-part, claims priority, and incorporates herein by reference to Ser. No. 13/855,713 filed Apr. 3, 2013; Ser. No. 14/623,497 filed Feb. 16, 2015; Ser. No. 14/799,569 filed Jul. 14, 2015; Ser. No. 15/193026 filed Jun. 25, 2016; and Ser. No. 14/952,907 filed Dec. 14, 2015.

### BACKGROUND

This invention relates generally to the field of data security, and particularly methods, apparatuses, and systems for securely creating, storing, and transmitting data.

Electronic devices generate a significant amount of data. Several remote electronic devices generating various types of data need to securely communicate and share such various types of data among multiple devices over a network. There is a need for such remote electronic devices to securely share said various types of data amongst the multiple devices, sometimes simultaneously.

The invention disclosed in this application provides novel methods, apparatuses, and systems for securely transmitting various types of data amongst the multiple remote electronic devices.

### BRIEF DESCRIPTION OF THE DRAWINGS

Features and advantages of the claimed subject matter will be apparent from the following detailed description of embodiments consistent therewith, which description should be considered with reference to the accompanying drawings, wherein:

FIG. 1 is a diagram illustrating a method and system that enables securely transmitting various types of data amongst the multiple remote electronic devices via a secure communication network in accordance with the teachings of the present invention;

FIG. 2 is a diagram illustrating a security gateway appliance including an additional network interface in accordance with the teachings of the present invention;

FIG. 3 is a diagram illustrating a security gateway appliance including at least one additional network interface enabled to support standard VLAN tagging methods in accordance with the teachings of the present invention;

FIG. 4 is a diagram illustrating a virtual machine including multiple physical network interfaces in accordance with the teachings of the present invention;

FIG. 5 is a diagram illustrating multiple virtual machines including a dedicated physical network interface in accordance with the teachings of the present invention;

FIG. 6 is a diagram illustrating the management server (4006) in accordance with the teachings of the present invention.

### SUMMARY

The figures illustrate methods, apparatuses, and systems for securely transmitting data between a first endpoint device and a second endpoint device comprising the first endpoint device coupled to a first security gateway via a first network infrastructure; the first security gateway coupled to a secure network; the second endpoint device coupled to a second security gateway via a second network infrastructure; the second security gateway coupled to the secure network; the first security gateway enabled to establish at least one secure tunnel via a network interface to couple the first endpoint device to the first security gateway via the first network infrastructure; the second security gateway enabled to establish at least one secure tunnel via a network interface to couple the second endpoint device to the second security gateway via the second network infrastructure; and the secure network enabled to establish a secure communication link directly between the first security gateway and the second security gateway enabling the first endpoint device to transmit data directly to the second endpoint device via the secure communication link.

Furthermore, the secure network includes at least one continuum server; at least one management server; at least one database; at least one relay server; and at least one message server. The continuum server may be enabled to: manage the authentication of multiple security gateways; coordinate a capability of communication of messages between the security gateways and with the management server; and establish a capability of streaming data sessions between first security gateway and the second security gateway. The management server may add the first endpoint device to an endpoint device list wherein the endpoint device list includes an identity of the first security gateway, a first certificate assigned to the first endpoint device, a name for the first endpoint device, and a first range of subnet address ranges assigned to the first endpoint device. In addition, the management server may add the second endpoint device to the endpoint device list wherein the endpoint device list includes an identity of the second security gateway, a second certificate assigned to the second endpoint device, a name for the second endpoint device, and a second range of subnet address ranges assigned to the second endpoint device. The management server may assign the first endpoint device and the second endpoint device to a first security group. The management server may also introduce the first endpoint device to the second endpoint device by providing the first endpoint device with a public certificate of the second endpoint device and a second range of subnet addresses of the second endpoint device, and the second endpoint device with a public certificate of the first endpoint device and a first range of subnet addresses of the first endpoint device. The management server may also enable the first endpoint device and the second endpoint device to communicate directly with the other via the secure communication link. The data communicated between the first endpoint device and the second endpoint device may be encrypted. The first endpoint device may be enabled to decrypt any encrypted data sent by the second endpoint device using the public certificate of the second endpoint device. Furthermore, the database may be enabled to store a public certificate of each security gateway so that the secure network can access the authentication certificates of the security gateways to authenticate the security gateways for secure communication directly with each other. Furthermore the packet relay server may be enabled to act as a rendezvous point for streaming data sessions between the first security gateway and the second security gateway. The messaging server may also be enabled to temporarily store and transit messages sent by the management server and the first security gateway and the second security gateway.

The figures also illustrate a management server enabled to manage access of multiple endpoint devices to a secure network comprising: the management server enabled to organize the multiple endpoint devices from a multitude of security gateways in an endpoint device list; the endpoint device list including the identity of the security gateway associated with an endpoint device, a certificate assigned to each endpoint device, a name for each endpoint device, and a subnet address range assigned to each endpoint device; the management server enabled to set up and manage security groups; the management server enabled to assign each endpoint device to different security groups; the management server enabled to introduce endpoint devices assigned to a common security group to the other endpoint devices assigned to the common security group by providing each endpoint device assigned to the common security group with the public certificate and subnet address range of each other endpoint device assigned to the common security group; and each endpoint device enabled to communicate directly with the other endpoint devices assigned to the same security group via a secure network. Furthermore each endpoint device may be enabled to decrypt any encrypted data sent by another endpoint device using a public key of the other endpoint device. The management server may be enabled to update a pool of subnet address ranges to indicate that the range of subnet address ranges assigned to any endpoint devices are in use. The management server may be enabled to remove an endpoint device from a security group including removing the public certificate for the other endpoint devices from the endpoint device using management messages and removing the subnet address ranges of the other endpoint devices from a routing table of the endpoint device. The certificate assigned to each endpoint device may be used to establish a secure tunnel within a security gateway.

The figures further illustrate a system for securely transmitting at least two types of data protocols between multiple endpoint devices including: a first endpoint device coupled to a first security gateway via a first network infrastructure; the first security gateway coupled to a secure network; a second endpoint device coupled to a second security gateway via a second network infrastructure; the second security gateway coupled to the secure network; the first security gateway and the second security gateway enabled to use a set of certificates associated with endpoint devices to establish multiple secure tunnels with multiple network interfaces to couple the endpoint devices to the security gateways via the network infrastructure; the secure network enabled to establish at least one secure tunnel directly between the first security gateway and the second security gateway enabling the first endpoint device to transmit data directly to the second endpoint device via the secure tunnel; the secure network comprising at least one continuum server; at least one management server; at least one database; at least one relay server; and at least one message server; a first secure tunnel, a second secure tunnel, and a third secure tunnel setup with the first security gateway and a first secure tunnel, a second secure tunnel, and a third secure tunnel setup with the second security gateway; and the end point devices associated with the first secure tunnel of the first security gateway are enabled to securely communicate a first data set protocol with the end point devices associated with the first secure tunnel of the second security gateway, the end point devices associated with the second secure tunnel of the first security gateway are enabled to securely communicate a second data set protocol with the end point devices associated with the second secure tunnel of the second security gateway, and the end point devices associated with the third secure tunnel of the first security gateway enabled to securely communicate a third data set protocol with the end point devices associated with the third secure tunnel of the second security gateway.

### DETAILED DESCRIPTION OF THE DRAWINGS

Although the following descriptions will proceed with reference being made to illustrative embodiments, many alternatives, modifications, and variations thereof will be apparent to those skilled in the art. Accordingly, it is intended that the claimed subject matter be viewed broadly. Examples are provided as reference and should not be construed as limiting. The term “such as” when used should be interpreted as “such as, but not limited to.”

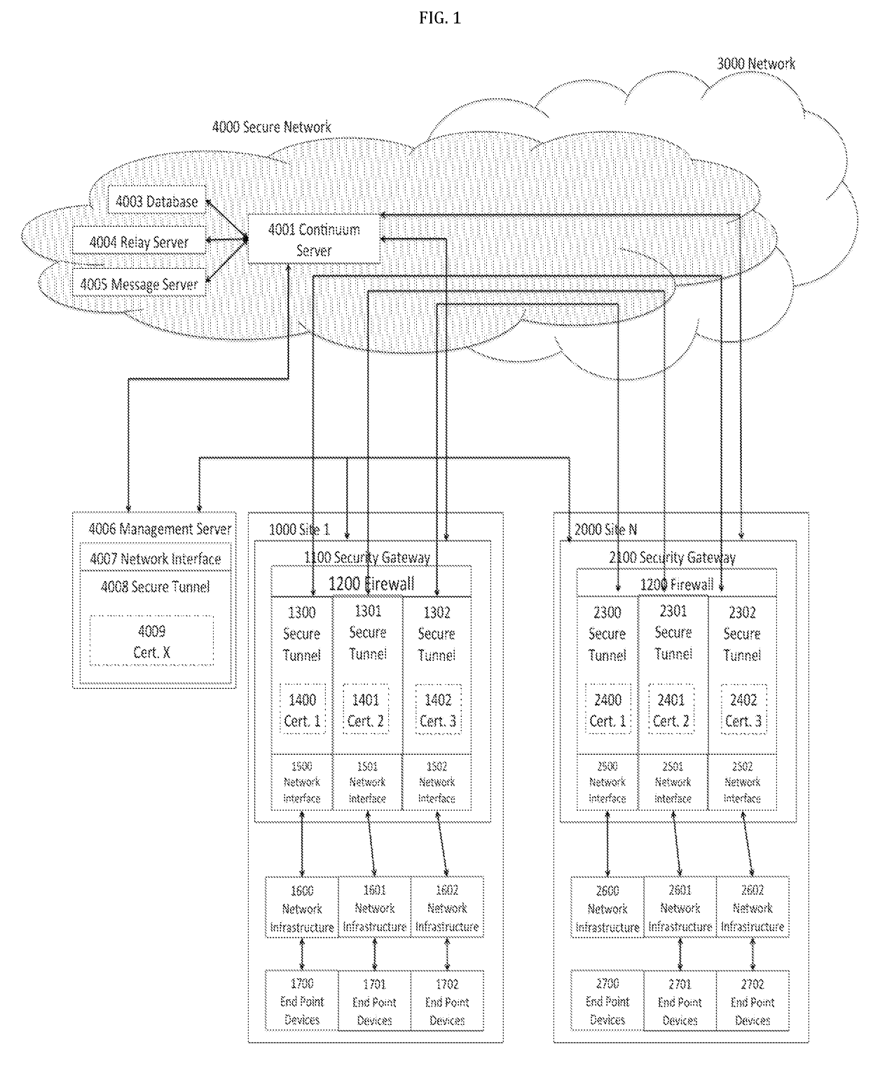

FIG. 1 illustrates methods, apparatuses, and systems for securely transmitting various types of data amongst the multiple remote endpoint devices wherein the multiple endpoint devices are located at different sites. At least one endpoint device (e.g. 1700, 1701, 1702) located at a first site (1000) is coupled to a first security gateway (1100) via a first network infrastructure (e.g. 1600, 1601, 1602). The first security gateway (1100) is coupled to a secure network (4000). At least one other second security gateway (2100) is also coupled to the secure network (4000). The secure network (4000) is enabled to establish a secure communication link with each of the security gateways, as described in further detail herein. The secure network (4000) is also enabled to establish a secure communication link between the first security gateway (1100) (1100) and the second security gateway (2100). The second security gateway (2100) also includes a least one other endpoint device (e.g. 2700, 2701, 2702) located at a second site (2000) that is coupled to the second security gateway (2100) via a second network infrastructure (e.g. 2600, 2601, 2602). The first security gateway (1100) and the second security gateway (2100) may each be enabled to block unauthorized access from the network while permitting outward communication to the network. The first security gateway (1100) and the second security gateway (2100) may also be enabled to establish multiple secure tunnels (e.g. 1300, 1301, 1302; 2300, 2301, 2302) with multiple network interfaces (e.g. 1500, 1501, 1502; 2500, 2501, 2502) to couple the endpoint devices to the security gateways via the network infrastructure.

The secure network (4000) ensures secure routing by authenticating the security gateways and transporting encrypted data. The secure network (4000) may include infrastructure; for example highly distributed, cloud-based network components that may include dedicated hardware as well as software applications running in data centers throughout the world. Data traveling between the security gateways via the secure network (4000) may be in encrypted form. The infrastructure of the secure network (4000) may not have any mechanism for accessing the data or encryption keys, much less decrypting the encrypted data being routed between the security gateways.

The secure network (4000) may include the following elements: a continuum server (4005); a management server (4006); a database (4003); a relay server (4004); and a message server (4005). The continuum server (4005) may be enabled to manage the authentication of multiple security gateways. The continuum server (4005) may also be enabled to coordinate the communication of messages between the security gateways and with the management server. The continuum server (4005) may also be enabled to establish streaming data sessions between the security gateways. The database (4003) may be enabled to store the public certificates of the security gateways such that the management server (4006) can access the authentication certificates of the security gateways to authentic the security gateways for secure communication directly with each other. The packet relay server (4004) may be enabled to act as a rendezvous point for streaming data sessions between the security gateways. The messaging server may be enabled to temporarily store and transit messages amongst the management server (4006) and the security gateways. The management server (4006) which may be protected by a cloud-based firewall and established as a secure endpoint device in a similar manner as the security gateway is enabled to perform certificate-management functions, such as signing/validating the public certificates associated with security gateways.

Physical Deployment of the Security Gateways

The security gateway either is shipped with or downloads an application enabled to set up the secure network (4000) from an appropriate distribution channel. During the installation process, the security gateway generates its own unique cryptographic key-pair, for example a public key and private keys, along with a certificate signing request (CSR) based on the public key and a list of capabilities, for example encryption strength, roles, and functionalities.

The security gateway's public key can be used by a trusted second security gateway (2100) to encrypt data intended for the security gateway, while the security gateway's private key is used to decrypt that encrypted data. Because only the private key can decrypt messages encrypted with the corresponding public key, it is stored securely on the device (using the AES-256 Key Wrap algorithm) and never exposed. An appropriate entropy source may be used to seed the deterministic random bit generator (DRBG) with a sequence of random bytes used to generate the key-pair. An acceptable level of entropy ensures that the private key is sufficiently random and thus, difficult for a potential attacker to determine. To secure data at rest (DAR) on the security gateway, the security gateway may also generate a volume key. The volume key may initially be created by the DRBG and then encrypted by the AES-256 Key Wrap algorithm using the key wrap key, for example derived from a user's password. The volume key may encrypt DAR using the AES-256 encryption algorithm in XTS mode.

Provisioning the Security Gateways

The security gateway establishes an identity with the secure network (4000) during the provisioning process. Each security gateway submits a newly generated CSR and capabilities list to the management server (4006). This process can occur automatically or manually. For automated provisioning, a secure-network management API (using an API key) can be used to submit the CSR to the management server (4006), for example via an HTTPS connection. For manual provisioning, the CSR and capabilities string may be provided to a user of the security gateway, allowing the user or a designated administrator to create a certificate in a secure network (4000) dashboard. The management server (4006) may validate the security gateway by signing the security gateway's public certificate, for example by using the ECDH key-agreement protocol—with the ECDSA digital signature algorithm with SHA-384 hash values—and the management server (4006)'s private key, and the security gateway may download the signed public certificate and initial configuration data (such as certificate revocation lists) from the management server (4006).

The public certificate may be a cryptographic fingerprint that binds the security gateway's identity with its public key. As the basic unit of identification and validation, the public certificate plays a central role in secure network (4000). Each security gateway may have multiple certificates.

Also as part of the provisioning process, each gateway may generate two zero-knowledge password reset (ZKPR) splits via exclusive disjunction (XOR) operation on a random number (created by the DRBG) with the key wrap key, for example derived from a user password. One split is stored on the gateway, while another is sent to the management server (4006). The security gateway encrypts the ZKPR split sent to the management server (4006) by creating a key, for example by using the ECDH key-agreement protocol and the management server (4006)'s public key, and then using the key to seed AES-256 in CBC mode. The ZKPR split will enable an administrator to remotely allow the user to unlock the security gateway, all without revealing the user's password.

Grouping the Security gateways

Communication only occurs between peer security gateways within secure and externally anonymous groups. Secure contact groups are created, edited, and disbanded via the management server (4006), either automatically/directly using the secure management API or manually by an administrator using a secure network (4000) dashboard. When the security gateway is added to an existing secure contact group, the public certificates of other group members—along with routing information and security gateway capabilities—are distributed to each of the security gateways, and the security gateway's public certificate is distributed to the rest of the group. This pre-population of friendly names allows for connections between peers to be rapidly established. When changes to a group occur, the list of friendly public certificates is updated for each affected security gateway.

Establishing Secure Presence

Presence is the act of a security gateway registering its online status with the secure network (4000). Presence enables the secure network (4000) to map a group of security gateways in real time without sharing or storing IP addresses, enabling the rapid establishment of connections. The use of public-facing IP addresses is limited to the mapping of security gateways by the continuum server (4005) with all other security gateways use public certificates as a means of identification. A first security gateway (1100) may attempt to connect to the nearest (or first available) continuum server (4005), for example via a temporary Transmission Control Protocol (TCP) socket. Before connecting to the secure network (4000) or another security gateway, the first security gateway (1100) and the continuum server (4005) authenticate each other using a challenge-response protocol, for example with a 32-byte device shared secret (DSS) generated on the first security gateway (1100) using the DRBG, with each device proving that it has a valid public certificate signed by the management server (4006) and that it is in possession of the corresponding private key. A public-facing IP address may be dynamically allocated to the security gateway. Presence information is shared between the continuum server (4005) via secure messaging and stored in the continuum server (4005)'s memory.

The first security gateway (1100) must maintain its presence connection by periodically updating its online status, for example via low-overhead User Datagram Protocol (UDP) messages containing the DSS and a counter value, with hash values created using the SHA-256 cryptographic hash function, with the continuum server (4005) at an interval specified by an application. By using the DSS, the first security server may keep its connection to the continuum server (4005) alive without the need to unlock the private key. The use of counter values provides protection against spoofing. For applications that do not utilize secure sessions, it may be possible to register with the secure network (4000) without the need for establishing presence, by registering the DSS with a continuum server (4005) and receiving an updated continuum server (4005) list in return.

Secure Communication

Once the first security gateway (1100) has registered with the secure network (4000), it may share secure messages, for example text strings, raw sensor measurements, or status updates with peer security gateways. The first security gateway (1100) may also share secure streaming sessions, for example voice calls, video calls, and video feeds with peer security gateways. The first security gateway (1100) may also share secure streaming sessions, for example sub-net traffic from devices hidden behind the secure gateway, allowing network communication of any kind between sub-nets behind different secure gateways. The first security gateway (1100) may share secure off-device storage with peer security gateways via public cloud (e.g. a cloud service provider) or private cloud (e.g. a enterprise network).

To send a secure message to another security gateway within its secure contact group, the first security gateway (1100) first encrypts the message by creating a key (e.g. using The elliptic curve Diffie—Hellman (ECDH) and the receiving security gateway's public key) and then using the key to seed AES-256 in CBC mode; the encrypted message may be given a unique hash value using SHA-256. The message is sent to the continuum server (4005) with which the first security gateway (1100) has established a secure presence connection. If necessary, the continuum server (4005) may replicate the message to other continuum server (4005)s via the reliable messaging servers. It may also be necessary for the message to be temporarily stored until the receiving security gateway starts a secure presence connection.

To receive a secure message from another security gateway within its secure contact group, the first security gateway (1100) must first subscribe to any messages that have been addressed to it. To do so, the first security gateway (1100) and the continuum server (4005) with which the first security gateway (1100) has a presence connection authenticate each other (e.g. using a challenge-response protocol and SHA-256 hash values). The continuum server (4005) then notifies the reliable messaging server, which adds the subscribing first security gateway (1100) as a trusted peer. As with presence, the first security gateway (1100) must maintain its subscription by periodically updating its online status (e.g. via messages containing the message subscription secret—MSS—and a counter value, with hash values created using SHA-256) with the continuum server (4005) at an interval specified by an application. Once subscribed, the message is published to the first security gateway (1100)'s queue in the reliable messaging server, which then delivers the message to the first security gateway (1100). The first security gateway (1100) decrypts the message by recreating the key (e.g. by using ECDH and its private key).

To initiate a secure streaming session with another security gateway within its secure contact group, the first security gateway (1100) must first reserve a packet relay server (4004). To do so, the first security gateway (1100) and the continuum server (4005) with which the first security gateway (1100) has a presence connection authenticate each other (e.g. using a challenge-response protocol and SHA-256 hash values). The continuum server (4005) then reserves the nearest (or first available) packet relay server (4004).

The continuum server (4005) encrypts the public-facing IP address of the packet relay server (4004) by creating a key (e.g. by using the first security gateway (1100)'s DSS) and then using the key to seed AES-256 in CBC mode. The continuum server (4005) then sends the encrypted IP address to the first security gateway (1100), which decrypts the IP address by recreating the key (e.g. using its DSS). Once the packet relay server (4004) is reserved, the first security gateway (1100) re-encrypts the IP address for the accepting security gateway and then sends the encrypted IP address to the accepting security gateway via the continuum server (4005). Through the packet relay server (4004), the first security gateway (1100) and the accepting security gateway authenticate each other and exchange ECDH ephemeral keys before generating a unique ephemeral key for the session to seed AES-256 in GCM mode.

During the streaming session, the first security gateway (1100) and the accepting security gateway continuously encrypt outgoing ciphertext blocks (e.g. TCP and/or UDP) and decrypts incoming ciphertext blocks, with the packet relay server (4004) transporting the packets. When one or both the first security gateway (1100) and the accepting security gateway cease the session, the packet relay server (4004) closes the tunnel.

In addition to one-to-one messaging and streaming, the first security gateway (1100) can send messages to multiple security gateways and set up multi-peer streaming sessions. To enable group communication, the first security gateway (1100) must first define the attributes for the group, including a group ID, group name, list of member certificates, group owner, and group key. The first security gateway (1100) encrypts the attributes for each group member by creating a key (e.g. by using ECDH and the receiving security gateway public key) and then using the key to seed AES-256 in CBC mode. Each encrypted set of attributes is sent to the appropriate security gateway via the continuum server (4005). The first security gateway (1100) may then create a multi-destination welcome message for the group. This message is encrypted using the group key to seed AES-256 in CTR mode. The message is placed into the queue (e.g. in the reliable messaging server) of every destination security gateway.

Group messaging may be enabled by multi-destination messages. The message format is similar to that of one-to-one messaging, but also contains the group ID, the version of the group key, and a 32-bit CRC checksum. The message is encrypted using the group key to seed AES-256 in CTR mode. The message is placed into the queue (in the reliable messaging server) of every destination security gateway.

Group streaming may be enabled by the ability of packet relay server (4004)s to replicate sessions. Once the packet relay server (4004) is reserved, the first security gateway (1100) re-encrypts the IP address (using the group key to seed AES-256 in CTR mode) as a multi-destination message addressed to all the other security gateways to be invited to the session. The message is placed into the queue (in the reliable messaging server) of every destination security gateway. During the streaming session, the packet relay server (4004) replicates each packet to all of the other security gateways invited into the group streaming session. The packet format is similar to that of one-to-one streaming, but also contains the version of the group key and the key use (e.g. messaging, video, voice, etc.).

Revocation of a Security Gateway

There are several cases in which a security gateway may need to be revoked from a secure contact group. For example, the security gateway may reach the end of its lifecycle, or it may be reassigned or repurposed, or it may be lost or stolen. This process can occur via a designated administrator with a secure network (4000) dashboard, or it can occur via API calls by using a security network API directly. The management server (4006) may create a new certificate revocation list (CRL), which may be encrypted by creating a key (e.g. by using ECDH and the security gateway's public key) and then using the key to seed AES-256 in CBC mode. The CRL may be sent to the continuum server (4005), which then may replicate the CLR to the other continuum server (4005)s via the reliable messaging servers. The continuum server (4005)s may distribute the updated CRL to the affected security gateway within a secure contact group, including the revoked security gateway. When the revoked security gateway attempts to connect to the secure network (4000), it will be blocked from communicating with other security gateways or performing other security network functions.

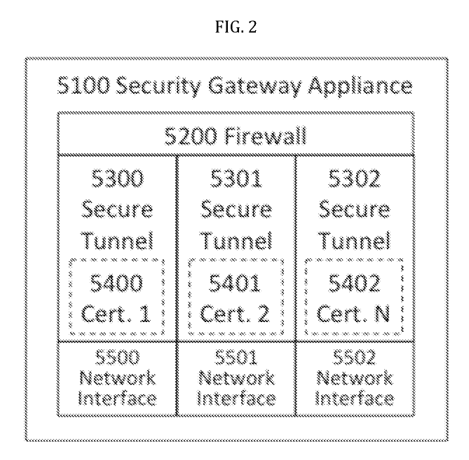

FIG. 2 illustrates a physical security gateway appliance 5100 including an additional network interface. This additional network interface may be enabled to couple to the network, such as the Internet, to couple to the continuum server (4005). The security gateway may also include a firewall (5200) and multiple secure tunnels (e.g. 5300, 5301, 5302) wherein each secure tunnel is established by the previously mentioned steps to establish a secure network (4000) via the network and continuum server (4005). Next each secure gateway may include at least one physical network interface (e.g. 5500, 5501, 5502) enabled to couple to the network infrastructures within each remote site. In some instances the secure gateway may include one physical network interface for each secure tunnel. At least one security gateway may be deployed at each remote site.

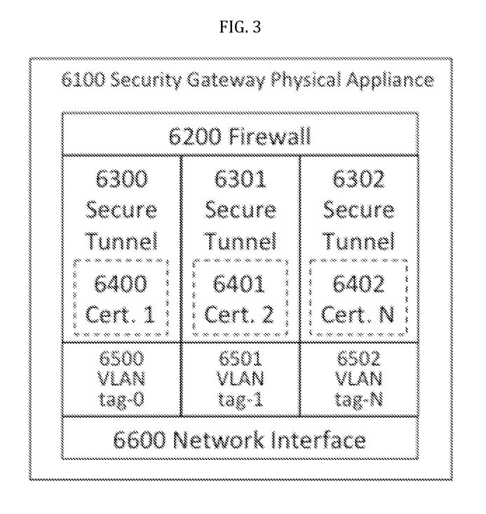

FIG. 3 shows a security gateway appliance (6100) including at least one additional network interface enabled to couple to the network, such as the Internet, to interface with the continuum server (4005). The security gateway may also include a firewall (6200) and multiple secure tunnels (e.g. 6300, 6301, 6302) wherein each secure tunnel is established by the previously mentioned steps to establish a secure network (4000) via the network and continuum server (4005). Next the security gateway may include at least one additional network interface (6600) enabled to support standard VLAN tagging methods including at least one VLAN tag (6500, 6501, 6502) for each locally isolated security group. The network interface includes at least one VLAN tag for each locally isolated security group to connect to the network infrastructures within each remote site. At least one security gateway may be deployed at each remote site.

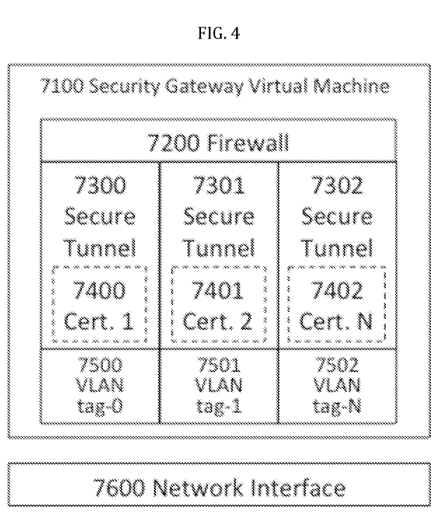

FIG. 4 shows a security gateway virtual machine (7100) including multiple physical network interfaces. The security gateway virtual machine (7100) includes at least one additional network interface enabled to couple to the network, such as the Internet, to interface with the continuum server (4005). The security gateway virtual machine (7100) may also include a firewall (7200) and multiple secure tunnels (e.g. 7300, 7301, 7302) wherein each secure tunnel is established by the previously mentioned steps to establish a secure network (4000) via the network and continuum server (4005). Next the security gateway virtual machine (7100) may include at least one additional network interface (7600) enabled to support standard VLAN tagging methods including at least one VLAN tag (7500, 7501, 7502) for each locally isolated security group. The network interface includes at least one VLAN tag for each locally isolated security group to connect to the network infrastructures within each remote site. Alternatively, the security gateway virtual machine (7100) may include at least one physical network interface enabled to couple to the network infrastructures within each remote site. In such instances the security gateway virtual machine may include one physical network interface for each secure tunnel. At least one security gateway virtual machine may be deployed at each remote site.

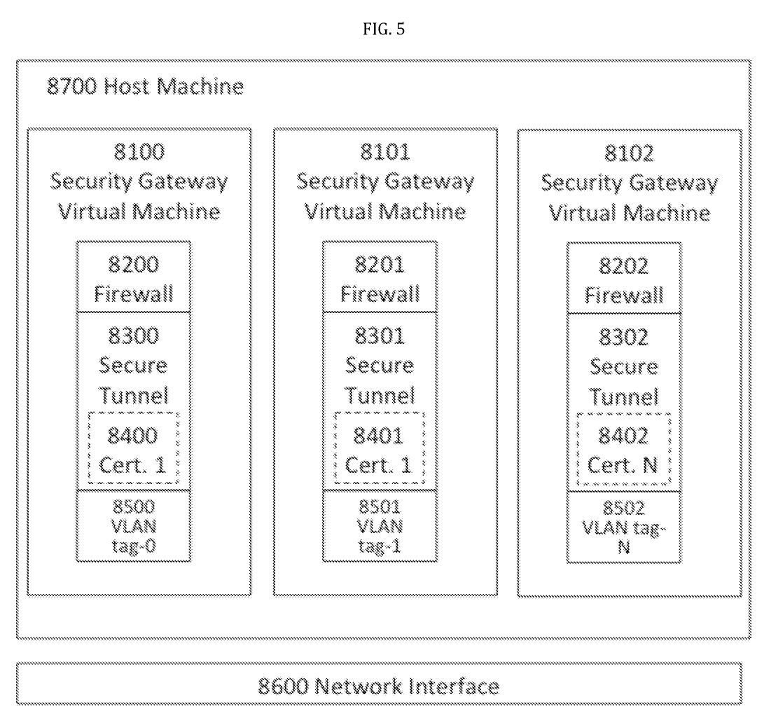

FIG. 5 is a diagram illustrating an example where the security gateway may include multiple virtual machines (e.g. 8100, 8101, 8102) deployed with a host machine (e.g. server) (8700) at each remote site. The security gateway may include at least one network interface enabled to couple to the network, such as the Internet, to interface with the continuum server (4005). Each security gateway virtual machine (e.g. 8100, 8101, 8102) may also include a firewall (e.g. 8200, 8201, 8202) and multiple secure tunnels (e.g. 8300, 8301, 8302) wherein each secure tunnel is established by the previously mentioned steps to establish a secure network (4000) via the network and continuum server (4005). Next each security gateway virtual machine may include at least one firewall and at least one additional network interface enabled to support standard VLAN tagging methods including at least one VLAN tag (8500, 8501, 8502) for each locally isolated security group. The network interface includes at least one VLAN tag for each locally isolated security group to connect to the network infrastructures within each remote site. Alternatively, the security gateway may include at least one physical network interface enabled to couple to the network infrastructures within each remote site. In such instances the security gateway may include one physical network interface for each secure tunnel. At least one security gateway virtual machine may be deployed at each remote site.

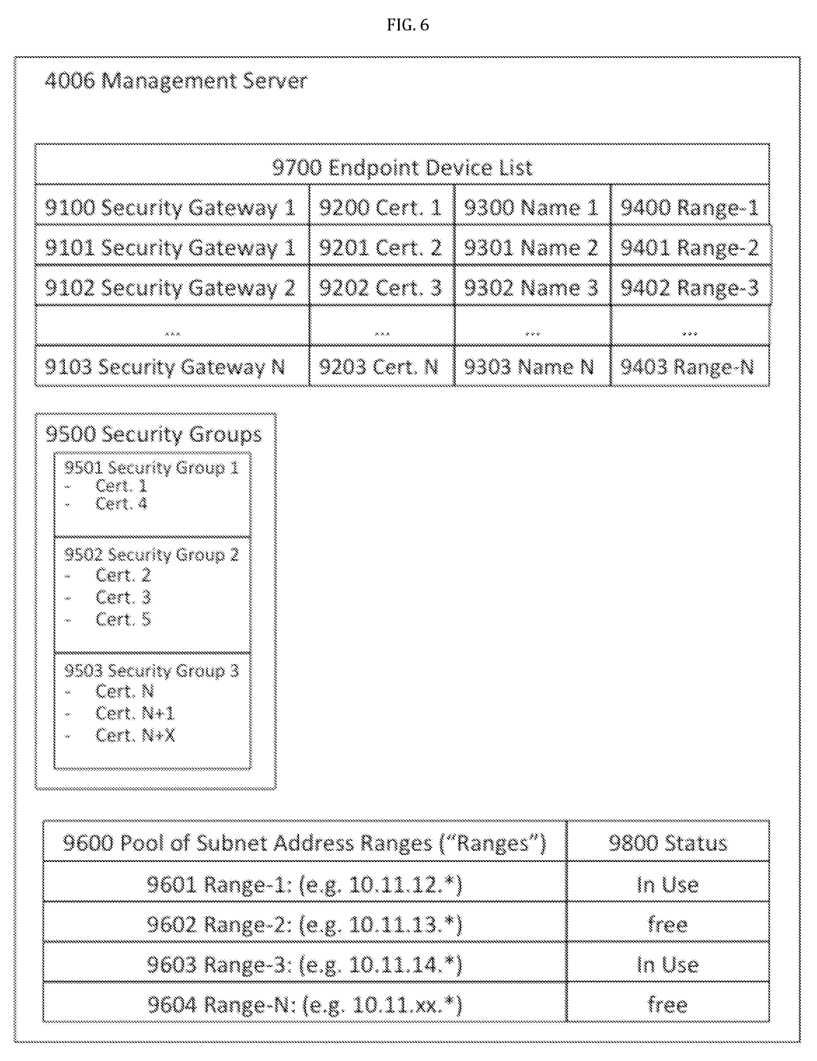

FIG. 6 shows the management server (4006). In addition to the functions described above, the management server (4006) is also enabled to manage the endpoint devices, the certificates, the pool of subnet address ranges, and the security groups. The multiple endpoint devices from the multiple security gateways may be organized within an endpoint device list (9700). Each endpoint device list (9700) endpoint device list (9700) may include the security gateway associated with the endpoint device, the certificate assigned to the endpoint device, a name for the endpoint device, and the subnet address ranges assigned to the endpoint device. Each endpoint device is assigned a subnet address range by the management server (4006). The management server (4006) is enabled to establish and manage any number of endpoint devices in the endpoint device list (9700). The management server (4006) may also be enabled to set up and manage security groups. The management server (4006) may be enabled to assign endpoint devices to different security groups (9500). The management server (4006) also introduces each endpoint device that has been assigned to a common security group (e.g. 9501, 9502, 9503) to the other endpoint devices also assigned to the common security group. The management server (4006) may accomplish such introduction by providing each endpoint device assigned to a common security group with the public certificate (e.g. 9200, 9201, 9202, 9203) and subnet address range (e.g. 9300, 9301, 9302, 9303) of each other endpoint device assigned to the common security group. Each endpoint device would then be enabled to communicate directly with the other endpoint devices assigned to the same security group via the secure communication link established in the previous steps. Each endpoint device would be enabled to decrypt any encrypted data sent by another endpoint device using the public key. The management server (4006) would also include a pool of subnet address ranges (9600) along with a status of each subnet address range (9800).

For example, when a first endpoint device is added to a first security gateway (1100) the first security gateway (1100) would communicate the identifying information to the management server (4006) via the secured network connection. The management server (4006) would then add the first endpoint device to the endpoint device list (9700) and annotate at least the identity of the security gateway (e.g. the first security gateway (1100)), the certificate assigned to the first endpoint device (e.g. Cert. 1), a name for the first endpoint device (e.g. Name 1), and the range of subnet address ranges assigned to the first endpoint device (e.g. Range-1).

Next when a third endpoint device is added to a second security gateway (2100) the second security gateway (2100) would communicate the identifying information to the management server (4006) via the secured network connection. The management server (4006) would then add the third endpoint device to the endpoint device list (9700) and annotate at least the identity of the security gateway (e.g. the second security gateway (2100)), the certificate assigned to the third endpoint device (e.g. Cert. 3), a name for the third endpoint device (e.g. Name 3), and the range of subnet address ranges assigned to the third endpoint device (e.g. Range-3).

Next the management server (4006) may assign the first endpoint device and the third endpoint device to a first security group (e.g. Security Group 1). The management server (4006) also introduces the first endpoint device and the third endpoint device to each other by providing the first endpoint device with the public certificate and subnet address range of the third endpoint device, and the third endpoint device with the public certificate and subnet address range of the first endpoint device. Each endpoint device receives the subnet address range dynamically assigned to the other endpoint device so that each endpoint device is enabled to update its routing tables. The first endpoint device and the third endpoint device are then enabled to communicate directly with the other endpoint device via the secure network (4000) established as previously disclosed herein. The first endpoint device and the third endpoint device are then enabled to decrypt any encrypted data sent by the other endpoint device using the public keys. The management server (4006) would then update the pool of subnet address ranges to indicate that the range assigned to the first endpoint device and the range assigned to the third endpoint device are in use (e.g. Range-1 and Range-3 are “In Use”). The management server (4006) may be enabled so that the subnet address range may be assigned manually or automatically. For example with the manual assignment, an operator would manually specify the subnet addresses for each of the remote endpoint devices via the management server (4006). The management server (4006) would then communicate the manual assignment information to all of the endpoint devices in the secure group.

The management server (4006) may also be enabled to remove an endpoint device from a security group. The management server (4006) is enabled to remove the public certificates for the other endpoint devices using management messages along with the subnet address ranges from the endpoint devices routing table. The management server (4006) may also be enabled to update the endpoint device list (9700), security groups, and the pool of address ranges status.

This invention also enables the use of certificates to establish any number of secure tunnels with each security gateway. Each secure tunnel can be set up to enable end point devices in different layers to communicate with other end point devices at a different location in the same communication layer. For example, a first secure tunnel, a second secure tunnel, and a third secure tunnel may be setup with the first security gateway (1100) and a first secure tunnel, a second secure tunnel, and a third secure tunnel may be setup with the second security gateway (2100) such that the end point devices associated with the first secure tunnel of the first security gateway (1100) are enabled to securely communicate with the end point devices associated with the first secure tunnel of the second security device. Again for example, the end point devices associated with the second secure tunnel of the first security gateway (1100) are enabled to securely communicate with the end point devices associated with the second secure tunnel of the second security device. Furthermore, for example, the end point devices associated with the third secure tunnel of the first security gateway (1100) are enabled to securely communicate with the end point devices associated with the third secure tunnel of the second security device. Each set of end point devices (e.g. 1700 endpoint devices associated with 2702 end point devices, 1701 endpoint devices associated with 2701 end point devices, and 1702 endpoint devices associated with 2700 end point devices) may include different type of communication layers associated with different communication protocols or applications (e.g. SCADA, email, internet of things, etc.).

Using standard VLAN and VPN technology would require all VLANs to be compressed into a single VPN tunnel using proprietary communication methods. This invention also supports both a hub-and-spoke model (e.g. several clients connecting to a single server) as well as a mesh model (e.g. all the clients enabled to communicate directly with one another, or a subset thereof). The invention also enables the security gateways and secure tunnels to sit behind additional external inbound-blocked firewalls making such devices invisible and not addressable via the network.

The data transmitted via this invention may include instantly transmitted data, for example in a voice or video conference call, or a delayed transmission, for example such as email or instant messaging, or stored on shared data for long-term repeated access, for example a network hard drive and/or a server for secure file sharing. The network may be either a wired or wireless communication network. The network may include a public or private network such as the internet, intranet, telecommunications system, secure messaging service, or other network capable of transmitting electronic data.

The endpoint devices, the security gateway, the management server (4006), the database (4003), the relay server (4004), the message server (4005), the firewall, the network interfaces, the network infrastructure, and other components of the invention may include internal hardware such as a processor, memory, and communication features. The endpoint devices, the security gateway, the management server (4006), the database (4003), the relay server (4004), the message server (4005), the firewall, the network interfaces, the network infrastructure, and other components of the invention may include software applications enabled to encrypt and decrypt data before sending the data through the network. The data encryption may be accomplished using any data encryption method such as Advanced Encryption Standard (“AES”). The endpoint devices, the security gateway, the management server (4006), the database (4003), the relay server (4004), the message server (4005), the firewall, the network interfaces, the network infrastructure, and other components of the invention may include smart phones, tablet PC's, notebook PC's, desktop PC's, remote monitoring devices, cameras, or sensors. The endpoint devices, the security gateway, the management server (4006), the database (4003), the relay server (4004), the message server (4005), the firewall, the network interfaces, the network infrastructure, and other components of the invention may be used for any type of communication, computing, or electronic operation. Furthermore, the endpoint devices, the security gateway, the management server (4006), the database (4003), the relay server (4004), the message server (4005), the firewall, the network interfaces, the network infrastructure, and other components of the invention may comprise a physical storage device such as a hard drive, series of hard drives, SSD memory, SD Card, or any other type of local volatile or non-volatile memory. The invention is also applicable to both mobile devices and fixed devices since either type are commonly used to transmit data to and from other mobile and fixed devices via a communication network. Throughout this description the endpoint devices, the security gateway, the management server (4006), the continuum, the database (4003), the relay server (4004), the message server (4005), the firewall, the network interfaces, the network infrastructure, and other components of the invention, however software components can also be used to perform the actions of any of such devices. Furthermore, the cryptographic components enabled to perform encryption and decryption may rely on asymmetric cryptography. For example, AES-GCM encryption has been described, but other methods may be used such as ECDH for key agreements, use of shared secrets, hard coded passwords, and one-time pads.

Throughout this description, references were made to devices coupled together. Such coupling includes a manner that allows the exchange and interaction of data, such that the operations and processes described may be carried out. For example, the devices may be coupled with electrical circuitry, or through wireless networks that allow the devices to transfer data, receive power, execute the operations described, and provide structural integrity. Reference was also made to interactions amongst devices via a network, however the invention is scalable to be enabled with any number of devices, servers, and/or computers than described in the specification. For example, any number of devices, networks, and servers, and/or computers may be utilized to enable this invention.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

The hereinafter expressed claims are hereby expressly incorporated into this Detailed Specification, with each claim standing on its own as a separate embodiment of the invention. Furthermore, while some embodiments described herein include some but not other features included in other embodiments, combinations of features of different embodiments are meant to be within the scope of the invention, and form different embodiments, as would be understood by those skilled in the art.

What is claimed:

1. A system for securely transmitting data between a first endpoint device and a second endpoint device comprising:
the first endpoint device coupled to a first security gateway via a first network infrastructure;
the first security gateway coupled to a secure network;
the second endpoint device coupled to a second security gateway via a second network infrastructure;
the second security gateway coupled to the secure network;
the first security gateway enabled to establish at least one secure tunnel via a network interface to couple the first endpoint device to the first security gateway via the first network infrastructure;
the second security gateway enabled to establish at least one secure tunnel via a network interface to couple the second endpoint device to the second security gateway via the second network infrastructure; and
the secure network enabled to establish a secure communication link directly between the first security gateway and the second security gateway enabling the first endpoint device to transmit data directly to the second endpoint device via the secure communication link.

2. The system of claim 1 wherein the secure network includes at least one continuum server; at least one management server; at least one database; at least one relay server; and at least one message server.

3. The system of claim 2 wherein the continuum server is enabled to: manage the authentication of multiple security gateways; coordinate a capability of communication of messages between the security gateways and with the management server; and establish a capability of streaming data sessions between first security gateway and the second security gateway.

4. The system of claim 2 wherein the management server adds the first endpoint device to an endpoint device list wherein the endpoint device list includes an identity of the first security gateway, a first certificate assigned to the first endpoint device, a name for the first endpoint device, and a first range of subnet address ranges assigned to the first endpoint device.

5. The system of claim 2 wherein the management server adds the second endpoint device to the endpoint device list wherein the endpoint device list includes an identity of the second security gateway, a second certificate assigned to the second endpoint device, a name for the second endpoint device, and a second range of subnet address ranges assigned to the second endpoint device.

6. The system of claim 2 wherein the management server assigns the first endpoint device and the second endpoint device to a first security group.

7. The system of claim 2 wherein the management server introduces the first endpoint device to the second endpoint device by providing the first endpoint device with a public certificate of the second endpoint device and a second range of subnet addresses of the second endpoint device, and the second endpoint device with a public certificate of the first endpoint device and a first range of subnet addresses of the first endpoint device.

8. The system of claim 2 wherein the management server enables the first endpoint device and the second endpoint device to communicate directly with the other via the secure communication link.

9. The system of claim 2 wherein the data communicated between the first endpoint device and the second endpoint device is encrypted.

10. The system of claim 2 wherein the first endpoint device is enabled to decrypt any encrypted data sent by the second endpoint device using the public certificate of the second endpoint device.

11. The system of claim 2 wherein the database is enabled to store a public certificate of each security gateway so that the secure network can access the authentication certificates of the security gateways to authenticate the security gateways for secure communication directly with each other.

12. The system of claim 2 wherein the packet relay server is enabled to act as a rendezvous point for streaming data sessions between the first security gateway and the second security gateway.

13. The system of claim 2 wherein the messaging server is enabled to temporarily store and transit messages sent by the management server and the first security gateway and the second security gateway.

14. A management server enabled to manage access of multiple endpoint devices to a secure network comprising:
the management server enabled to organize the multiple endpoint devices from a multitude of security gateways in an endpoint device list;
the endpoint device list including the identity of the security gateway associated with an endpoint device, a certificate assigned to each endpoint device, a name for each endpoint device, and a subnet address range assigned to each endpoint device;
the management server enabled to set up and manage security groups;
the management server enabled to assign each endpoint device to different security groups;
the management server enabled to introduce endpoint devices assigned to a common security group to the other endpoint devices assigned to the common security group by providing each endpoint device assigned to the common security group with the public certificate and subnet address range of each other endpoint device assigned to the common security group; and
each endpoint device enabled to communicate directly with the other endpoint devices assigned to the same security group via a secure network.

15. The system of claim 14 wherein each endpoint device is enabled to decrypt any encrypted data sent by another endpoint device using a public key of the other endpoint device.

16. The system of claim 14 wherein the management server is enabled to update a pool of subnet address ranges to indicate that the range of subnet address ranges assigned to any endpoint devices are in use.

17. The system of claim 14 wherein the management server is enabled to remove an endpoint device from a security group including removing the public certificate for the other endpoint devices from the endpoint device using management messages and removing the subnet address ranges of the other endpoint devices from a routing table of the endpoint device.

19. The system of claim 14 wherein the certificate assigned to each endpoint device is used to establish a secure tunnel within a security gateway.

20. A system for securely transmitting at least two types of data protocols between multiple endpoint devices comprising:
a first endpoint device coupled to a first security gateway via a first network infrastructure;
the first security gateway coupled to a secure network;
a second endpoint device coupled to a second security gateway via a second network infrastructure;
the second security gateway coupled to the secure network;
the first security gateway and the second security gateway enabled to use a set of certificates associated with endpoint devices to establish multiple secure tunnels with multiple network interfaces to couple the endpoint devices to the security gateways via the network infrastructure;
the secure network enabled to establish at least one secure tunnel directly between the first security gateway and the second security gateway enabling the first endpoint device to transmit data directly to the second endpoint device via the secure tunnel;
the secure network comprising at least one continuum server; at least one management server; at least one database; at least one relay server; and at least one message server;
a first secure tunnel, a second secure tunnel, and a third secure tunnel setup with the first security gateway and a first secure tunnel, a second secure tunnel, and a third secure tunnel setup with the second security gateway; and
the end point devices associated with the first secure tunnel of the first security gateway are enabled to securely communicate a first data set protocol with the end point devices associated with the first secure tunnel of the second security gateway, the end point devices associated with the second secure tunnel of the first security gateway are enabled to securely communicate a second data set protocol with the end point devices associated with the second secure tunnel of the second security gateway, and the end point devices associated with the third secure tunnel of the first security gateway enabled to securely communicate a third data set protocol with the end point devices associated with the third secure tunnel of the second security gateway.
